(19) United States
(12) Patent Application Publication
(10) Pub. No.: US 2026/0333544 A1
(43) Pub. Date: Oct. 22, 2026

(54) LIGHTING CONTROL METHOD AND LIGHTING CONTROL SYSTEM

(71) Applicant: AUO Display Plus Corporation, Hsinchu City (TW)

(72) Inventors: Ssu-Ying YANG, Hsinchu City (TW); Yung-Jen CHEN, Hsinchu City (TW); Chung-Kuan TING, Hsinchu City (TW)

(21) Appl. No.: 19/705,914

(22) Filed: Jun. 12, 2026

(30) Foreign Application Priority Data
Aug. 26, 2025 (TW) 114132514

(51) Int. Cl. H05B 47/11; H05B 47/125; H05B 47/13; H05B 47/17; H05B 47/175

(52) U.S. Cl. CPC H05B 47/11; H05B 47/125; H05B 47/13; H05B 47/17; H05B 47/1985

(57) ABSTRACT

A lighting control method for a lighting space is provided. The lighting space includes sub-regions, each including at least one light source. The lighting control method includes the following steps: receiving an image of the lighting space; analyzing an object number and a current illuminance of each sub-region based on the image; calculating a preset illuminance of each sub-region based on the object number of the target sub-region, the object number of a neighbor sub-region, and a distance between the target sub-region and the neighbor sub-region; and calculating a lighting output value of the light source based on a difference between the preset illuminance and the current illuminance of the corresponding sub-region. A lighting control system is also provided, which includes an analyzing module for executing the above lighting control method, an optical sensor for obtaining the image, the light sources, and a control module for controlling the light sources.

### CROSS REFERENCE TO RELATED APPLICATION

This application claims the priority benefit of Taiwan Patent Application No. 114132514, filed on Aug. 26, 2025. The entirety of the mentioned above patent application is hereby incorporated by reference herein and made a part of this specification.

BACKGROUND OF THE DISCLOSURE

### 1. Field of the Disclosure

The present disclosure relates to a lighting control method and a lighting control system for executing the same. Specifically, the present disclosure relates to a lighting control method with integrated consideration of various factors and a lighting control system for executing the same.

### 2. Description of the Prior Art

With the advancement of smart building and energy-saving technologies, modern lighting control has gradually evolved from traditional manual or timer-based switching systems to intelligent lighting control systems that integrate environmental sensors and logical algorithms. Such systems have been widely applied in offices, commercial spaces, public facilities, and residential environments. Common implementations include using infrared or acoustic sensors to detect human motion and activate lighting, using ambient light sensors to switch on streetlights at night, and employing booking systems to automatically turn on lighting in meeting rooms.

However, existing intelligent lighting control technologies still have several limitations and areas for improvement in practical applications. For example, the sensing accuracy of human presence sensors and ambient light sensors is limited, making it difficult to precisely detect the distribution of occupants and light patterns in a space. Furthermore, conventional technologies lack logical control of lighting distribution and brightness gradation, often resulting in all luminaires within a large area being fully turned on or off simultaneously, which leads to excessive ineffective lighting and energy waste. In addition, current designs seldom incorporate considerations of visual comfort, which may cause overly rapid brightness adjustments or distinct bright-dark boundaries within the space, leading to visual fatigue for users.

Therefore, there is a need to develop an improved intelligent lighting control method capable of dynamically monitoring the distribution of occupants, ambient light conditions, and other relevant factors in real time, and performing adaptive adjustments based on human-centric requirements, thereby enhancing lighting quality, visual comfort, and overall energy efficiency.

### SUMMARY OF THE DISCLOSURE

A purpose of the present disclosure is to provide a lighting control method, which utilizes intelligent image analysis technique to obtain real-time information, such as occupant distribution and ambient brightness, in order to adjust relevant lighting control parameters. The method dynamically regulates light source output, thereby improving lighting quality and reducing energy waste caused by ineffective illumination.

Another purpose of the present disclosure is to provide a lighting control method, which utilizes intelligent image analysis technique to regulate light source output corresponding to occupant distribution and ambient brightness, thereby enhancing visual comfort and reducing sharp luminance transitions or distinct bright-dark boundary.

Still another purpose of the present disclosure is to provide a lighting control system for obtaining images of the lighting space, deriving an optimal lighting configuration based on information such as occupant distribution and ambient brightness extracted from images, and controlling the light source to meet the corresponding output requirements, thereby achieving intelligent lighting control.

The lighting control method is configured to be executed in a lighting space. The lighting space includes a plurality of sub-regions, wherein each sub-region at least includes a light source. The lighting control method includes the following steps: a step of receiving an image of the lighting space; a step of analyzing an object number and a current illuminance of each sub-region based on the image; a step of calculating a preset illuminance of each sub-region; and a step of calculating a lighting output value of the light source. The step of calculating the preset illuminance of a target sub-region includes: calculating the preset illuminance based on the object number of the target sub-region, the object number of a neighbor sub-region, and a distance between the target sub-region and the neighbor sub-region. The step of calculating the lighting output value of the light source in the target sub-region is based on a difference between the preset illuminance and the current illuminance of the target sub-region.

On the other hand, the lighting control system includes an analyzing module, an optical sensor, a plurality of light sources, and a control module. The analyzing module is used to execute the aforementioned lighting control method and send an operation message including the lighting output values. The optical sensor is in signal communication with the analyzing module and is used to obtain the image of the lighting space and transfer the image to the analyzing module. The light sources is disposed in the lighting space. The control module is in signal communication with the analyzing module and the light sources. The control module is used to receive the operation message and adjust the brightness of each light source based on the corresponding lighting output value.

### BRIEF DESCRIPTION OF THE DRAWINGS

FIG. 1 is a simplified flow chart of the lighting control method in an embodiment.

FIG. 2 is a schematic diagram of the lighting control system for executing the lighting control method in the embodiment shown in FIG. 1.

FIG. 3 is a schematic diagram of the lighting space in the embodiment shown in FIG. 1.

FIG. 4 is a schematic diagram of the lighting space and the overlapped partition images in another embodiment.

FIG. 5 is a flow chart of the step of calculating the preset illuminance in the embodiment shown in FIG. 1.

FIG. 6 is a schematic diagram of the illuminance of some sub-regions in the embodiment shown in FIG. 1.

FIG. 7 is a flow chart of the step of adjusting the preset illuminance in an embodiment.

FIG. 8 is a schematic diagram of the illuminance variation of the associating set in the embodiment shown in FIG. 7.

FIG. 9 is a flow chart of the step of calculating the illuminance-adjusting factor in the embodiment shown in FIG. 7.

FIG. 10 is a flow chart of the step of adjusting the preset illuminance in the embodiment shown in FIG. 7.

FIG. 11 is a simplified flow chart of the step of lighting compensation of the auxiliary region in an embodiment.

FIG. 12 is a flow chart of the step of calculating the compensatory illuminance in the embodiment shown in FIG. 11.

FIG. 13 is a schematic diagram of the lighting space in the embodiment shown in FIG. 11.

FIGS. 14A, 14B, and 14C are schematic diagrams of the step of balancing the load of the light sources, the step of warning light source overload, and the step of warning light source bad performance, respectively, in an embodiment.

FIG. 15 is a schematic diagram of an object moving in the lighting space in another embodiment.

FIG. 16 is a schematic diagram of the preset moving route in the lighting space in another embodiment.

### DETAILED DESCRIPTION OF THE DISCLOSURE

Various embodiments will be described below, and a person having ordinary skill in the art can easily understand the spirits and principles of the present disclosure referring to this specification accompanied by the drawings. However, although some particular embodiments will be specifically illustrated herein, these embodiments are only exemplary, and are not regarded as limiting or exhaustive in all respects. Therefore, for a person having ordinary skill in the art, various changes and modifications to the present disclosure should be obvious and can be easily achieved without departing from the spirits and principles of the present disclosure.

In the attached figures, for the purpose of clarification, the thicknesses of layers, films, panels, regions and the like are amplified. The embodiments described herein should not be interpreted as limited to the relative sizes or specific shapes of the regions shown herein. For instance, areas shown or described as flat may generally have rough and/or nonlinear features. It should be understood that, when an element such as a layer, a film, a panel, a region or a substrate is described as “being on” or “being connected to” another element, it may be directly on or connected to another element, or there may be other elements therebetween. On the other hand, when an element is described as “directly existing on” or “being directly connected to” another element, there is no element therebetween. As used in the present specification, a “connection” may be a physical and/or electrical connection. In addition, an “electrical connection” or “coupling” means that other elements may exist therebetween

In the whole specification, the same marks represent the same element. It should be understood that, even though the terms such as “first”, “second”, “third” may be used to describe an element, a part, a region, a layer and/or a portion in the present specification, but these elements, parts, regions, layers and/or portions are not limited by such terms. Such terms are merely used to differentiate an element, a part, a region, a layer and/or a portion from another element, part, region, layer and/or portion. Therefore, in the following discussions, a first element, portion, region, layer or portion may be called a second element, portion, region, layer or portion, and do not depart from the teaching of the present disclosure.

The terminology used herein is intended to describe particular embodiments only and are not limiting. As used herein, the singular forms “a”, “an”, and “the” are intended to include the plural forms, including “at least one”, unless the content dictates otherwise. “Or” means “and/or”. As used herein, the term “and/or” includes any and all combinations of one or more of the associated listed items. It will also be understood that, when used in this specification, the terms “comprising” and/or “including” designate the presence or addition of stated features, regions, integers, steps, operations, elements, and/or components, but do not exclude the presence or addition of one or more other features, regions, integers, steps, operations, elements, components and/or combinations thereof.

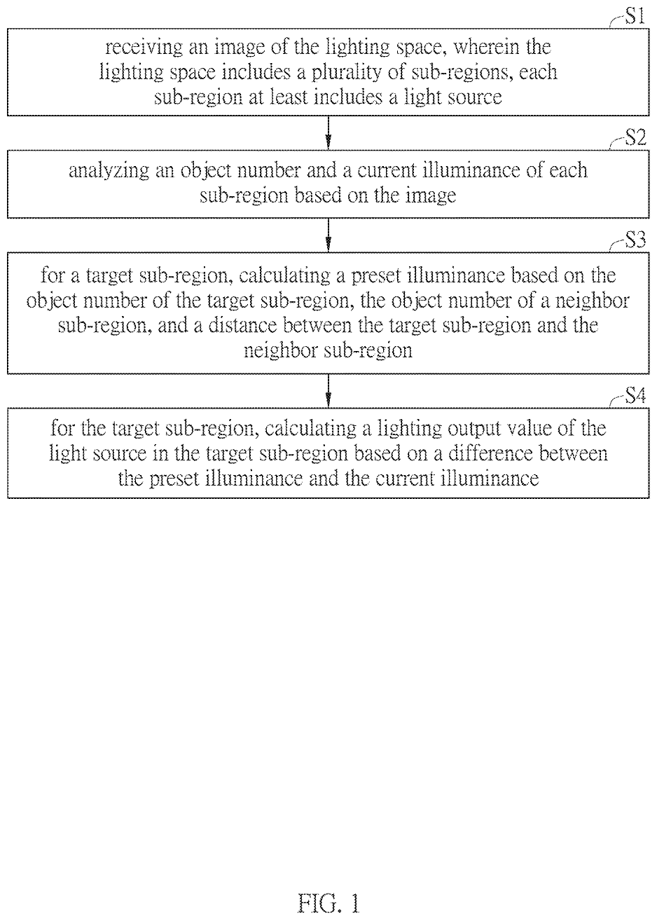

FIG. 1 shows a simplified flow chart of the lighting control method in an embodiment. The lighting control method is applied to a lighting space, wherein the lighting space includes a plurality of sub-regions and each sub-region at least includes a light source. The lighting control method includes the following steps S1 to S4. Step S1 includes receiving an image of the lighting space. The image may be obtained by an optical sensor such as a camera or the like. The dividing principle of the sub-regions may be varied to meet the required lighting conditions. The step S2 includes analyzing the object number and the current illuminance of each sub-region based on the image. The object may be defined based on the scene type or the lighting demands. For example, when the lighting space refers to an office, the object may be defined to correspond to a person; or, when the lighting space refers to a parking lot, the object may be defined to include a person and/or a vehicle, but not limited thereto. The current illuminance represents the actual brightness of the scene at the time the image is captured. The step S3 is the step of calculating the preset illuminance of each sub-region, wherein for a target sub-region, at least one sub-region neighboring to the target sub-region may be defined as a neighbor sub-region, and the preset illuminance may be calculated based on the object number of the target sub-region, the object number of the neighbor sub-region, and the distance between the target sub-region and the neighbor sub-region. In other words, the preset illuminance of each sub-region is not only dependent on the object number itself but also dependent on the object number of its neighbor sub-region, as well as the distance between the two sub-regions. The step S4 is the step of calculating the lighting output value of each light source, wherein the lighting output value may be calculated based on the difference between the preset illuminance and the current illuminance of the target sub-region accommodating the light source (or where the light source illuminates). Then, the light source in the target sub-region can receive a message including the lighting output value of the corresponding sub-region, and the brightness of the light source is adjusted accordingly, bringing the illuminance of each sub-region to approach the preset illuminance.

FIG. 2 shows a schematic diagram of the lighting control system for executing the lighting control method. The lighting control system includes the optical sensor 100, the analyzing module 200, the control module 300, and light sources 400. The optical sensor 100 is disposed in the lighting space 1 and is in signal communication with the analyzing module 200, which is configured to obtain the image 101 of the lighting space 1 and transfer the image 101 to the analyzing module 200. The optical sensor 100 may include, but not limited to, a unidirectional camera, an omnidirectional camera, an infrared sensor, an illuminance sensor, or combinations thereof. After receiving the image 101, the analyzing module 200 execute the aforementioned lighting control method and send an operation message 201 including the lighting output values of the light sources in the sub-regions. The control module 300 is configured to stay in signal communication with the analyzing module 200 and the light source 400 to receive the operation message 201 and adjust the brightness of each light source based on the corresponding lighting output value. The control module 300 may respectively send a corresponding control signal to each sub-region. For example, the control module 300 may send a first control signal 301A to the sub-region 10A and send a second control signal 301B to the sub-region 10B. For those sub-regions including multiple light sources 400 (such as the sub-region 10A with two light sources 400 therein), the control module 300 may control each light source to exhibit the same brightness; or, the control module 300 may alternatively adjust the brightness of each light source to a different level based on the luminous efficiency or operating condition corresponding thereto.

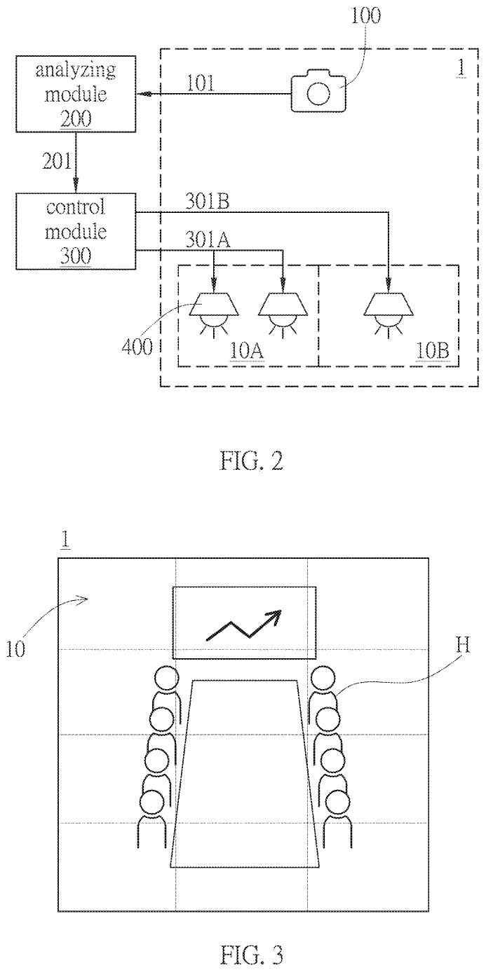

The steps of the lighting control method are respectively described as follows. As shown in FIG. 3, after obtaining the image in step S1, the corresponding lighting space 1 may be divided into a plurality of sub-regions 10 based on the planar coordinates in the image. The lighting space 1 may, for example, be a meeting room, which can be divided into a two-dimensional array of sub-regions 10. By defining the boundary between sub-regions 10 based on the image, a computational model can be rapidly constructed, enabling application of the lighting control method to various space type. On the other hand, the sub-regions 10 may be defined based on physical objects or boundaries (not shown in the figures) in the lighting space 1. For example, each sub-regions 10 may cover a seat, a workstation, or, a light source. By defining the sub-regions 10 corresponding to the tangible object, the arrangement of sub-regions 10 can reflect the personnel distribution pattern or the light source coverage. Once the sub-regions 10 are defined based on the first image, the following analysis for the same lighting space 1 may adopt the same definition of the sub-regions 10.

In the step S2 of analyzing the image, the location of each object H (such as a human body and/or face) in the image may be identified by artificial intelligence technology. Then, the sub-region 10 containing the object H is determined. If the object H falls into multiple sub-regions 10, the object H may be assigned to one of these sub-regions 10 based on the area proportion of the object H in each sub-region 10, the head position of the object H, or other factors. Alternatively, the object H may contribute to the object number of more than one sub-region 10 at the same time. In addition, the current illuminance of each sub-region 10 may be determined by the color/brightness of the corresponding area in the image. Specifically, a standard image with known illuminance can serve as the standard of the subsequent illuminance comparison. For example, the light source may be turned on at a standard brightness (e.g., maximum brightness) in the absence of ambient light to capture a standard image with a standard illuminance (e.g., defined as the working illuminance). Alternatively, multiple standard images may be captured under different lighting conditions, while an illuminance meter is positioned in the lighting space 1 for measuring the illuminance of each sub-region 10 (with one or more measurement points per sub-region 10), so as to establish a correspondence between the standard images and the actual illuminance. Based on these methods, the object number and the current illuminance in each sub-region 10 can be obtained.

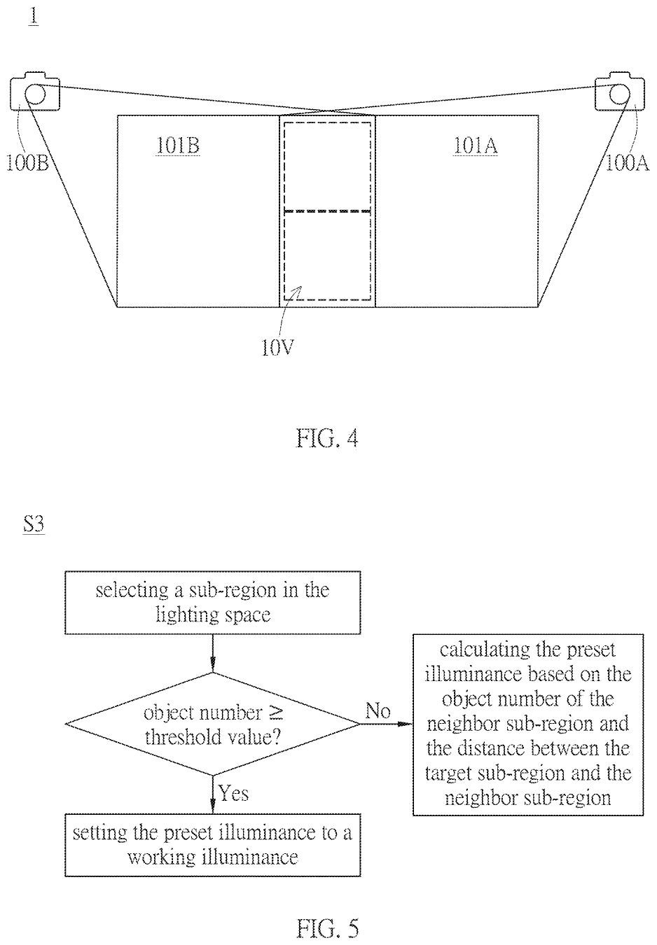

The aforementioned image of the lighting space may refer to a single image or a combination of images. For example, in a lighting space with large area or occluding objects, two or more optical sensors may be disposed to acquire a full image of the lighting space. Also, an optical sensor may be used to capture a plurality of images with different viewing angle. As shown in FIG. 4, two optical sensors 100A and 100B are disposed in the lighting space 1 to respectively capture two partition images 101A and 101B, wherein the partition images 101A and 101B are partially overlapped. For each sub-region 10V corresponding to the overlapped region of the partition images 101A and 101B, the partition object number and the partition current illuminance may be calculated based on each of the partition images 101A and 101B. Since different images may exhibit variations in image features such as sharpness and color, analysis results of the object number and/or the current illuminance of the same sub-region 10V based on different images may be different. Therefore, a selection rule for the parameters obtained from different images is provided as below. For example, in step S2, the object number of the sub-region 10V may be defined as the largest one of the partition object numbers obtained from multiple partition images, and the current illuminance of the sub-region 10V may be defined as the smallest one of the partition current illuminances obtained from multiple partition images. Based on these setting, the object number and the current illuminance are selected in order to achieve a relative higher preset illuminance, preventing insufficient lighting due to errors in image analysis.

In the step S3 of calculating the preset illuminance, the target illuminance of each sub-region (namely, a target sub-region) may be calculated based on the object number of the target sub-region and the object number of one or more neighboring sub-region which is located close to the target sub-region, and the distance between the target sub-region and each neighbor sub-region may be used as a weighted factor. FIG. 5 shows a flow chart of the step S3 in an embodiment, which includes the detailed steps of calculating the preset illuminance. First, a sub-region in the lighting space is selected as the target sub-region. Then, the object number of the target sub-region is compared with a threshold value, wherein the threshold value is defined based on the lighting requirement. For example, the threshold value may be defined as 1 in order to distinguish sub-regions with and without occupants. The threshold value may also be set to other value corresponding to different lighting requirements, and the object number may be compared with one or more threshold values. For example, the threshold value may include a series of values in ascending order respectively corresponding to illuminance levels from weak to strong. In this embodiment, in response to the object number of the target sub-region being greater than or equal to the threshold value, the target sub-region is defined to be in the working status and its preset illuminance is set to a working illuminance such as 500 lux. Conversely, in response to the object number of the target sub-region being less than the threshold value, the target sub-region is defined to be in the background status and its preset illuminance is calculated based on the object number of the neighbor sub-region and the distance between the target sub-region and the neighbor sub-region. In other words, when the target sub-region is in the background status and there is an occupant (or occupants) in the neighbor sub-region near the target sub-region, the preset illuminance of the target sub-region may be elevated to provide supplemental lighting to the neighbor sub-region and eliminate the bright-dark boundary.

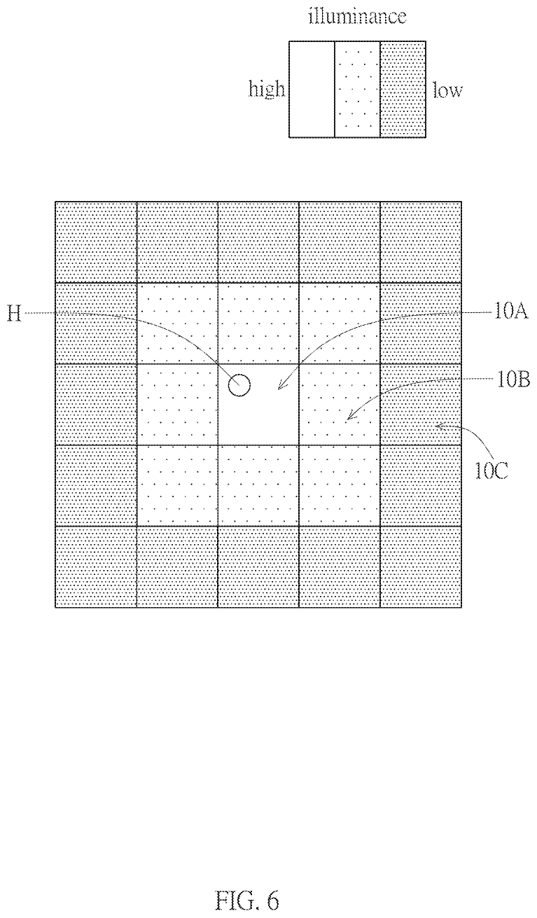

Specifically, for the target sub-region in the background status, as the object number in the neighbor sub-region increases or the distance between the target sub-region and the neighbor sub-region decreases, the preset illuminance of the target sub-region is set to a higher value. FIG. 6 shows a schematic diagram of the preset illuminance of a number of sub-regions, wherein the preset illuminance is calculated based on the method shown in FIG. 5. In this embodiment, the sub-region 10A includes an object H, so the object number of the sub-region 10A is counted as 1,which is found to be greater than or equal to the threshold value (for example, the threshold value may be established as 1), and the sub-region 10A is defined to be in the working status. Meanwhile, the object numbers of the sub-regions 10B and 10C close to the sub-region 10A are 0, so the sub-regions 10B and 10C are defined to be in the background status with object numbers less than the threshold value. Accordingly, the sub-region 10A in the working status has the highest preset illuminance. The sub-regions 10B locate relatively closer to the sub-region 10A, so each sub-region 10B has a medium preset illuminance. The sub-regions 10C locate relatively away from the sub-region 10A, so each sub-region 10C has the lowest preset illuminance. Based on this setting, a center-outward descending illuminance distribution can be achieved with a sub-region in the working status as the center, preventing the user in the center sub-region from perceiving a distinct bright-dark boundary. In addition, when the light source in a sub-region has a narrow lighting coverage, the light source in the neighbor sub-region may provide supplemental lighting, so as to increase lighting uniformity within the sub-region.

In an embodiment, the preset illuminance of the target sub-region in the background status may be calculated as the product of the object number of the neighbor sub-region, the weighted factor corresponding to the distance between the target sub-region and the neighbor sub-region, and the compensation illuminance. If there are multiple neighbor sub-regions for the target sub-region, the preset illuminance of the target sub-region may be calculated as the sum of the products corresponding to all neighbor sub-regions. For example, the preset illuminance may be calculated based on the following formula:

Eⱼ=max (E₀, Σwᵢeᵢ)

Eⱼ refers to the preset illuminance of the j-th sub-region in the lighting space. E₀ refers to the background illuminance, the lowest illuminance required in the lighting space. Σwᵢeᵢ refers to the sum of the weighted compensation illuminance, wherein i is an integer selected from 1 to N, and N is the total count of the sub-region in the lighting space. wᵢ refers to the illumination compensation weighted factor of the i-th sub-region, depending on the distance between the i-th sub-region and the j-th sub-region. For example, wᵢ increases as the distance decreases. eᵢ refers to the compensation illuminance contributed by the i-th sub-region, depending on the object number of the i-th sub-region. For example, eᵢ increases as the object number increases.

In other words, the preset illuminance (Eⱼ) may be calculated as the sum (Σwᵢeᵢ) of the weighted compensation illuminance corresponding to each sub-region in the lighting space, but no less than the background illuminance (E₀). For example, the background illuminance (E₀) may be defined as 50 lux. Therefore, even if there is no occupant around, a weak lighting is still provided to the sub-region in the background status, achieving the desired illumination atmosphere and enhancing safety. Based on different space type, the background illuminance (E₀) may be defined as 0 or other value.

The above equation is further explained as follows. wᵢ refers to the illumination compensation weighted factor of the i-th sub-region, which increases as the distance between the i-th sub-region and the j-th sub-region decreases. eᵢ refers to the compensation illuminance contributed by the i-th sub-region, which depends on the object number of the i-th sub-region and the lighting space type. For example, in the lighting space shown in FIG. 6, the illumination compensation weighted factor (wᵢ) of the sub-region 10A may be defined as 0.6 when calculating the preset illuminance (Eⱼ) of each sub-region 10B in the first surrounding layer of the sub-region 10A (not limited to being edge-or corner-adjacent), 0.4 when calculating the preset illuminance (Eⱼ) of each sub-region 10C in the second surrounding layer of the sub-region 10A, and 0 when calculating the preset illuminance (Eⱼ) of each sub-region in the third and any outer surrounding layers of the sub-region 10A (not shown in the figures). In addition, the compensation illuminance (eᵢ) contributed by the sub-regions with object numbers of 1, 2, and 3 may be arranged in ascending order. For example, the compensation illuminances (eᵢ) may be respectively defined as 400, 450, and 500 lux for the sub-regions with object numbers of 1, 2, and 3. Therefore, when calculating the preset illuminance (Eⱼ) of the sub-region 10B, the weighted compensation illuminance (wᵢeᵢ) contributed by the sub-region 10A which is close to the sub-region 10B may be considered. That is, the weighted compensation illuminance (wᵢeᵢ) is the product of the illumination compensation weighted factor (wᵢ=0.6) of the first surrounding layer and the compensation illuminance (eᵢ=400 lux) contributed by the sub-region with the object number of 1, resulting in 240 lux. Since the object numbers in other sub-regions equal 0, all sub-regions except for the sub-region 10A contributes zero compensation illuminance. Therefore, the preset illuminance (Eⱼ) of the sub-region 10B is calculated as 240 lux. On the other hand, the preset illuminance (Eⱼ) of the sub-region 10C is the product of the illumination compensation weighted factor (wᵢ=0.4) of the sub-region 10A, which locates in the second surrounding layer, and the compensation illuminance (eᵢ=400 lux) contributed by the sub-region 10A, which has the object number of 1, resulting in 160 lux. Based on this method, the preset illuminance of each sub-region can be determined based on the object number and distribution in the lighting space, providing precise lighting arrangement corresponding to the user needs.

In different lighting space type, the formula or parameters can be adjusted to achieve the desired lighting mode. For example, the correspondence between the illumination compensation weighted factor and the distance from a sub-region to another may be adjusted corresponding to the shape and arrangement of the sub-regions in the lighting space. For example, the distance from the central position of a sub-region to another may be used to define the illumination compensation weighted factor. In addition, the preset illuminance of the sub-region in the background status may be controlled not to exceed an upper limit such as 80% of the working illuminance. The above equations and parameters are merely illustrative of certain embodiments of the present disclosure and are not restrictive.

In the step S4 of calculating the lighting output value, the lighting output value of the light source in a sub-region may be calculated based on the comparison of the preset illuminance and the current illuminance of the sub-region. If the current illuminance is less than the preset illuminance, the lighting output value is reduced so that the resulting illuminance attains the preset illuminance. Conversely, if the current illuminance is greater than the preset illuminance, the lighting output value is elevated. The lighting output value may be represented in various forms, including, but not limited to, a relative ratio (such as 0% to 100%) or an integer (such as 0 to 10). A lighting output value of 100% may be mapped to the maximum brightness of the light source or the brightness corresponding to the working illuminance, but not limited thereto. The lighting adjustment mode of the light source may include, but not limited to, pulse-width modulation (PWM), digital addressable lighting interface (DALI) control, or analog voltage control (such as a 0-10 V control mode). According to the selected lighting adjustment mode, the control module may convert the lighting output value to the corresponding electric signal (such as the voltage or the switching frequency) and send the electric signal to the light source in the corresponding sub-region to control the brightness of the light source. After completing step S4, the next cycle of lighting control may be executed again from the step S1. The time interval between each cycle of lighting control may be adjusted based on the moving speed of the object in the lighting space. For example, the time interval may be set to 1 to 30 second, but not limited thereto. By iterating the above lighting control method, the current illuminance of the sub-region can gradually approach the preset illuminance.

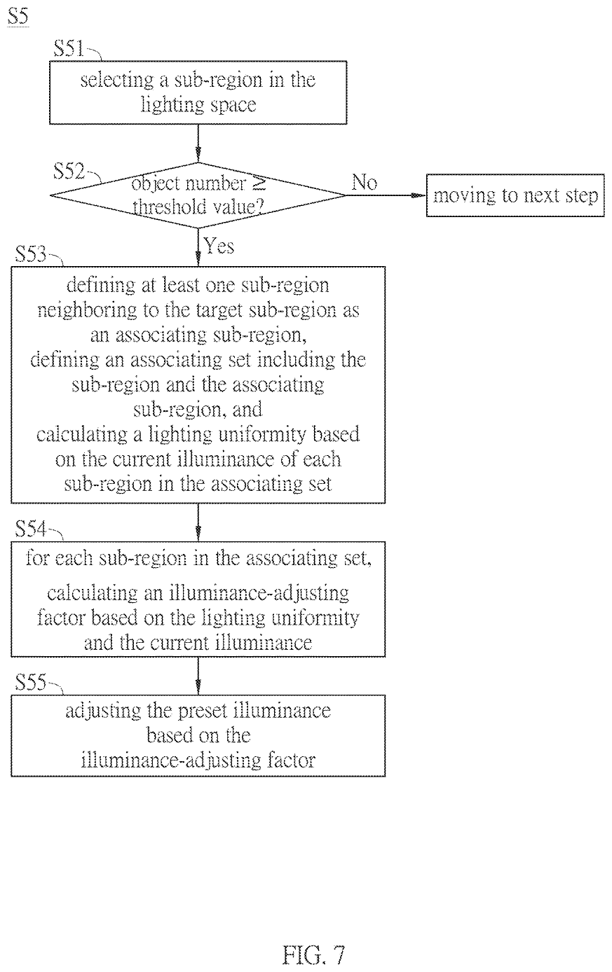

As shown in FIG. 7, the lighting control method of the present disclosure may further include the step S5 of the adjusting the preset illuminance, which may be executed after the step S3 of calculating the preset illuminance as mentioned in the aforementioned embodiments. First, a sub-region in the lighting space is selected (step S51), followed by determining whether the object number of the target sub-region reaches the threshold value which is defined based on the lighting requirement (step S52). If the object number is greater than or equal to the threshold value, the step of calculating the lighting uniformity is then performed (step S53). Conversely, if the object number is less than the threshold value, the step S53 of calculating the lighting uniformity and its relating steps (such as steps S54 and S55) are bypassed and the next step such as step S4 is then executed. In the step S53 of calculating the lighting uniformity, at least one sub-region neighboring to the target sub-region is defined as an associating sub-region, and an associating set is established to include the target sub-region and the associating sub-regions. Then, the lighting uniformity of the associating set is calculated based on the current illuminance of all sub-regions (that is, the target sub-region and the associating sub-regions) in the associating set. Specifically, the associating set may be defined to cover a range in which the user can sense significant brightness changes. For example, the associating set may be include all or a portion of the sub-regions in the lighting space. The lighting uniformity may be calculated based on the maximum value, the minimum value, the average value, or other statistical parameters of the current illuminances of the sub-regions in the associating set. For each sub-region in the associating set, an illuminance-adjusting factor is set based on the lighting uniformity and the current illuminance (step S54). Finally, the preset illuminance of each sub-region obtained in previous steps (for example, the step S3) is adjusted based on the illuminance-adjusting factor (step S55).

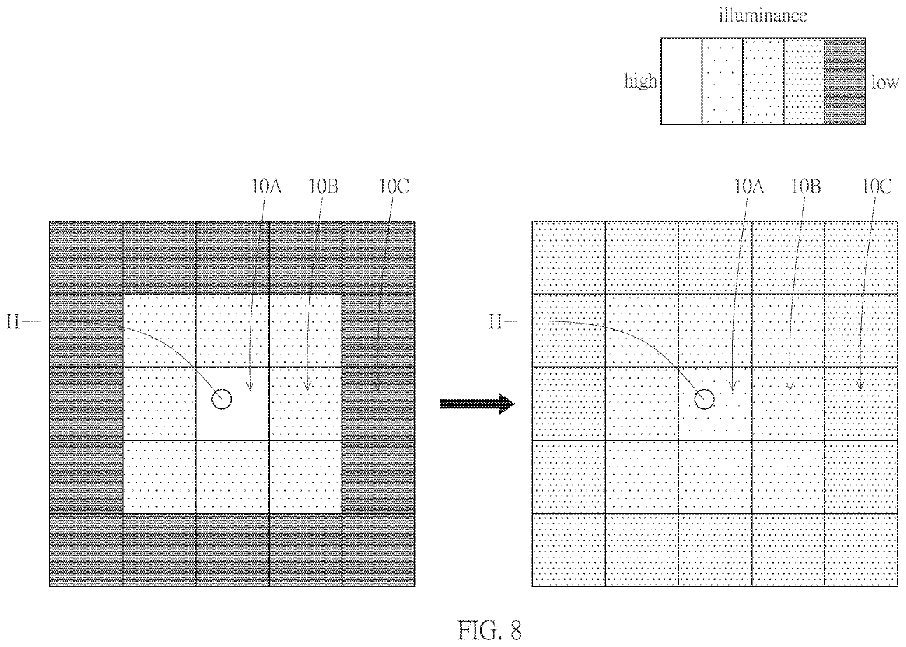

For example, in FIG. 8, the left drawing shows the current illuminance of the sub-regions in the associating set, and the right drawing shows the preset illuminance of the sub-regions in the associating set after executing the step of adjusting the preset illuminance. In order to emphasize the step of adjusting the preset illuminance, it is assumed that the current illuminance equals to the preset illuminance obtained in previous steps (for example, the step S3) for each sub-region in this embodiment. When the lighting uniformity of the associating set is too low (as shown in the left drawing), the preset illuminance of the sub-region with the highest preset illuminance (for example, the sub-region 10A) may be reduced, and the preset illuminance of the sub-region with the lowest preset illuminance (for example, the sub-region 10C) may be elevated, so as to increase the lighting uniformity. The distribution of the preset illuminance in the associating set after adjustment is shown as the right drawing. Based on this method, the lighting uniformity of the sub-regions surrounding the user can be increased, enhancing visual comfort of users.

In the step S53 of calculating the lighting uniformity, the size of the associating set is defined corresponding to the lighting space type, the area of each sub-region, the motion mode of the user, and other external factors. For example, as to a smaller space (such as a meeting room), the associating set may be defined to cover all sub-regions. As to a larger space (such as a parking lot) or a space with occluding objects (such as a storage room), the associating set may be defined to cover the target sub-region and one or two surrounding layers. For example, in the embodiment shown in FIG. 8, the object number of the sub-region 10A is counted as 1, and its associating set includes a 5×5 grid centered on the sub-region 10A, but not limited thereto. In addition, the lighting uniformity of the associating set may include a first lighting uniformity, for example, the ratio of the minimum value and the average value of the current illuminance in all sub-regions in the associating set, which reflects the visually perceived dark zones. Also, the lighting uniformity of the associating set may include a second lighting uniformity, for example, which is defined as the ratio of the minimum value and the maximum value of the current illuminance in all sub-regions in the associating set, which reflects the visually perceived bright-dark contrast.

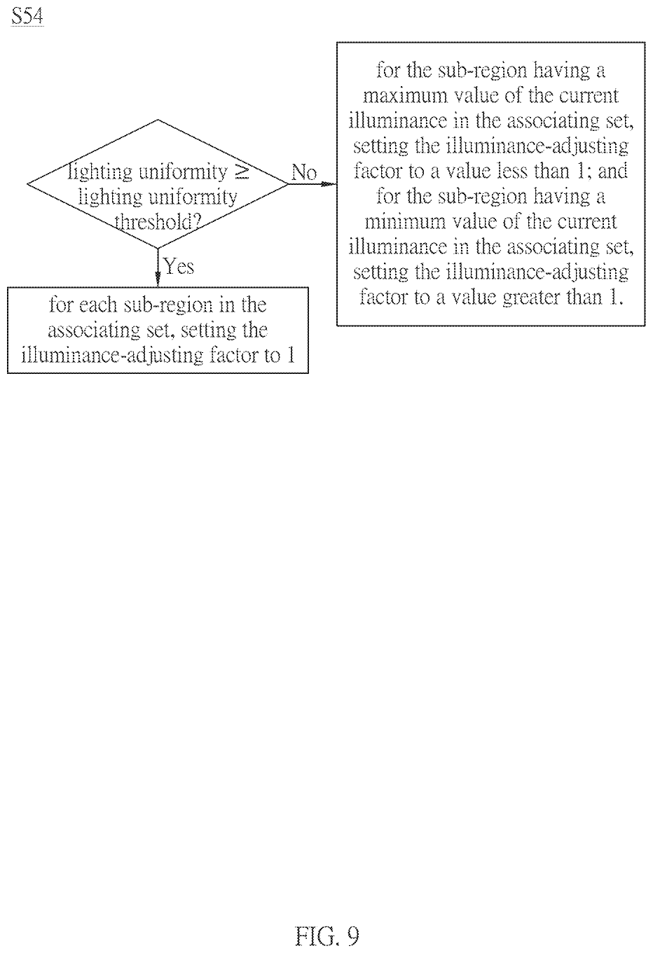

Referring to FIG. 9, the step S54 of calculating the illuminance-adjusting factor is further elaborated. First, in an associating set, the lighting uniformity is compared with a lighting uniformity threshold, wherein the lighting uniformity is defined based on the lighting space type and the lighting requirement. For example, during a presentation section in a meeting room, a high lighting uniformity is required to prevent visual discomfort; thus, the lighting uniformity threshold may be defined as 0.8. As in low-attention spaces such as lobbies or corridors, a low lighting uniformity (such as 0.5) may be defined for energy saving. Then, an illuminance-adjusting factor may be assigned to each sub-region in the associating set as a reference for adjusting the preset illuminance. In response to the lighting uniformity being greater than or equal to the lighting uniformity threshold, which indicates that the lighting uniformity meets the lighting requirement in the associating set, the illuminance-adjusting factor of each sub-region in the associating set is set to 1. That is, no adjustment is made to the preset illuminance of each sub-region in the associating set. Conversely, in response to the lighting uniformity being less than the lighting uniformity threshold, the preset illuminance may be adjusted to increase the lighting uniformity. For the sub-region having a maximum value of the current illuminance in the associating set, the illuminance-adjusting factor is set to a value less than 1 (such as 0.9). Meanwhile, for the sub-region having a minimum value of the current illuminance in the associating set, the illuminance-adjusting factor is set to a value greater than 1 (such as 1.1). The illuminance-adjusting factor may be determined based on the difference between the lighting uniformity and the lighting uniformity threshold. As the difference becomes larger, the illuminance-adjusting factor may depart further from 1.

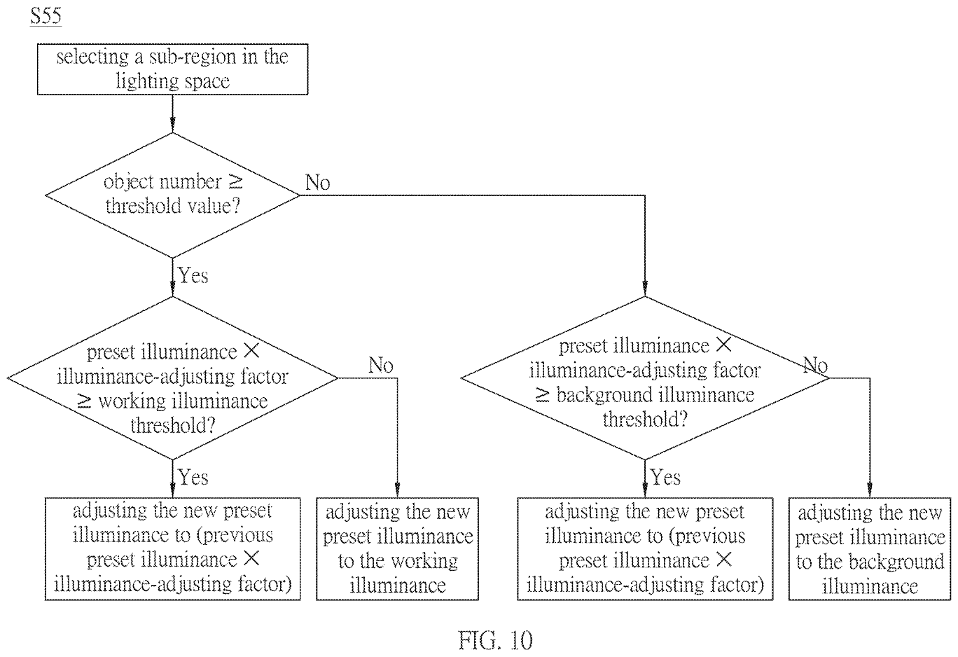

Referring to FIG. 10, the step S55 of adjusting the preset illuminance is further elaborated. First, a sub-region in the associating set is selected as the target sub-region. Then, the object number of the target sub-region is compared with a threshold value (such as 1). If the object number is greater than or equal to the threshold value, which indicates that the target sub-region is in the working status, the preset illuminance may be adjusted corresponding to a working illuminance threshold (such as 450 lux). Conversely, if the object number is less than the threshold value, which indicates that the target sub-region is in the background status, the preset illuminance may be adjusted corresponding to a background illuminance threshold (such as 50 lux). The above mentioned thresholds may be defined corresponding to the lighting space type, not restricted to the example value above. Next, for the target sub-region in the working status, the product of the preset illuminance and the illuminance-adjusting factor is compared with the working illuminance threshold. If the product of the preset illuminance and the illuminance-adjusting factor is greater than or equal to the working illuminance threshold, the new preset illuminance is adjusted to the product of the previous preset illuminance and the illuminance-adjusting factor; if the product of the preset illuminance and the illuminance-adjusting factor is less than the working illuminance threshold, the new preset illuminance is adjusted to the working illuminance threshold. Similarly, for the target sub-region in the background status, the same procedure is applied using the background illuminance threshold as the comparison basis instead. In other words, for the sub-region in the working status and the sub-region in the background status, the minimum values of their preset illuminances after adjustment are the working illuminance threshold and the background illuminance threshold, respectively. Based on this setting, the lighting uniformity in the area surrounding the user can be elevated while maintaining the basic illuminance level of each sub-region.

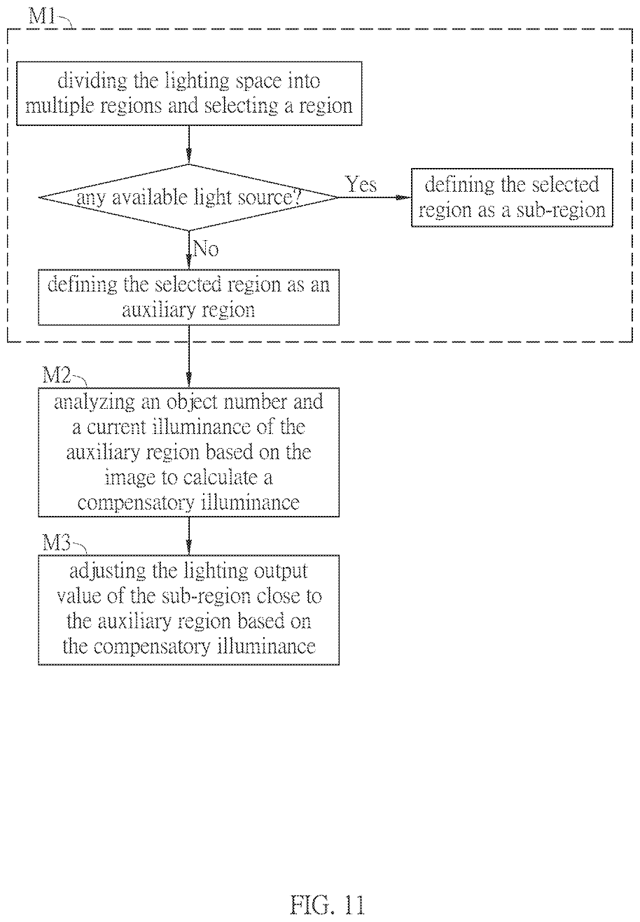

In an embodiment, the lighting control method may further include the step of lighting compensation, which refers to providing compensatory lighting for area without available light sources. When the planar coordinate of the image or the physical boundary of the lighting space is used as the reference to divide the lighting space into multiple regions, some regions may lack light sources or have a disabled light source (being malfunctioning or otherwise unavailable). In order to achieve proper illuminance in the regions without available light sources, the brightness of the light source in neighboring regions may be elevated for lighting compensation. As shown in FIG. 11, the step of lighting compensation includes steps M1 to M3. In the step M1 of determining auxiliary regions, the lighting space is divided into a plurality of regions based on the aforementioned dividing principle; afterwards, each region is either defined as a sub-region if including one or more available light sources, or defined as an auxiliary region if not including any available light source. Specifically, the auxiliary region may have no light sources installed, or all light sources in the auxiliary region may be disabled. For example, the light source may be disabled due to load balancing or component faults, but not limited to. Once the sub-regions and auxiliary regions in a lighting space are defined, the same definition can be employed thereafter. However, when the state of any lighting source changes, the determination may be carried out again. The lighting control method for sub-regions is described in the aforementioned embodiments (for example, the steps S1 to S4 shown in FIG. 1), so further details are omitted herein. For each auxiliary region, the step M2 is executed following to the step S1, wherein the object number and the current illuminance of the auxiliary region is analyzed based on the image and a compensatory illuminance is calculated based on the object number and the current illuminance. Finally, the step M3 is executed, wherein the lighting output value of at least one sub-region close to the auxiliary region is adjusted based on the compensatory illuminance, so that the current illuminance of the auxiliary region can be elevated to approach the required illuminance. Regarding the sequence of the illuminance adjustment steps for sub-regions and auxiliary regions, the step M3 may be performed subsequent to the step S4 (referring to FIG. 1) of calculating the lighting output value of the sub-region in order to adjust the lighting output value of the sub-region on the basis of the former steps.

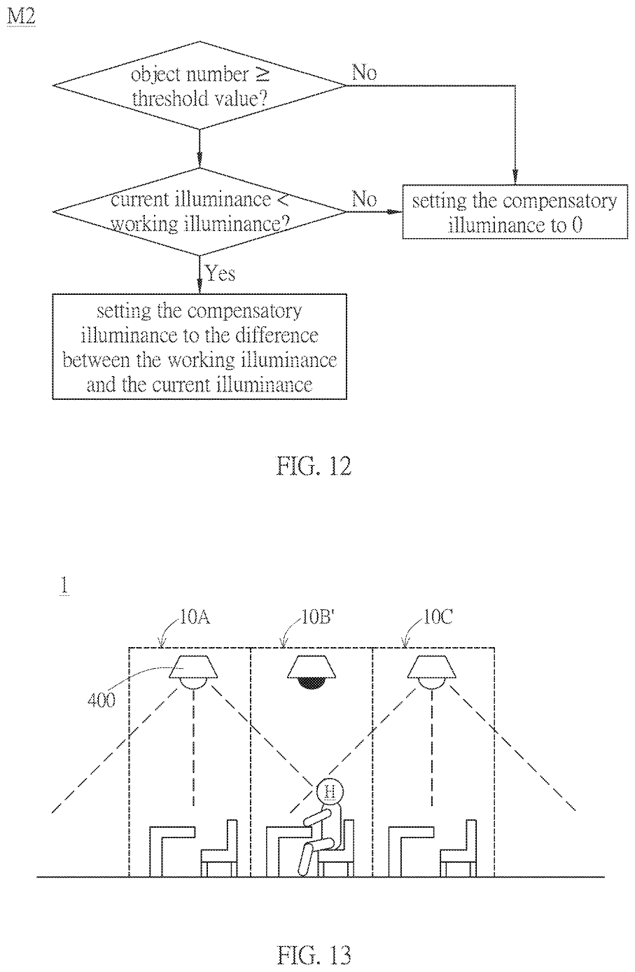

Referring to FIG. 12, the step M2 of calculating the compensatory illuminance is further elaborated. First, if the object number of the auxiliary region is greater than or equal to a threshold value (for example, the same threshold value as in the step S3 as shown in FIG. 5), the auxiliary region is defined to be in the working status and a corresponding compensatory illuminance is calculated in the next step; otherwise, if the object number of the auxiliary region is less than the threshold value, which indicates that the auxiliary region needs no lighting compensation, the compensatory illuminance is set to 0. Next, for each auxiliary region in the working status, the current illuminance is compared with a working illuminance, wherein the working illuminance may be defined corresponding to the lighting requirement of the lighting space. If the current illuminance is less than the working illuminance, the compensatory illuminance is set to the difference between the working illuminance and the current illuminance. Conversely, if the current illuminance is greater than or equal to the working illuminance, which indicates no compensatory lighting is needed, the compensatory illuminance is set to 0. Afterwards, in the step M3 of adjusting the lighting output value in the neighboring sub-region, for the auxiliary region with a compensatory illuminance larger than 0, the lighting output value of one or more sub-regions close to (for example, adjacent to) the auxiliary region is elevated proportionally to the compensatory illuminance, thereby providing indirect lighting to the auxiliary region. When the compensatory illuminance of the auxiliary region is 0, the lighting output value of the neighboring sub-regions is not adjusted.

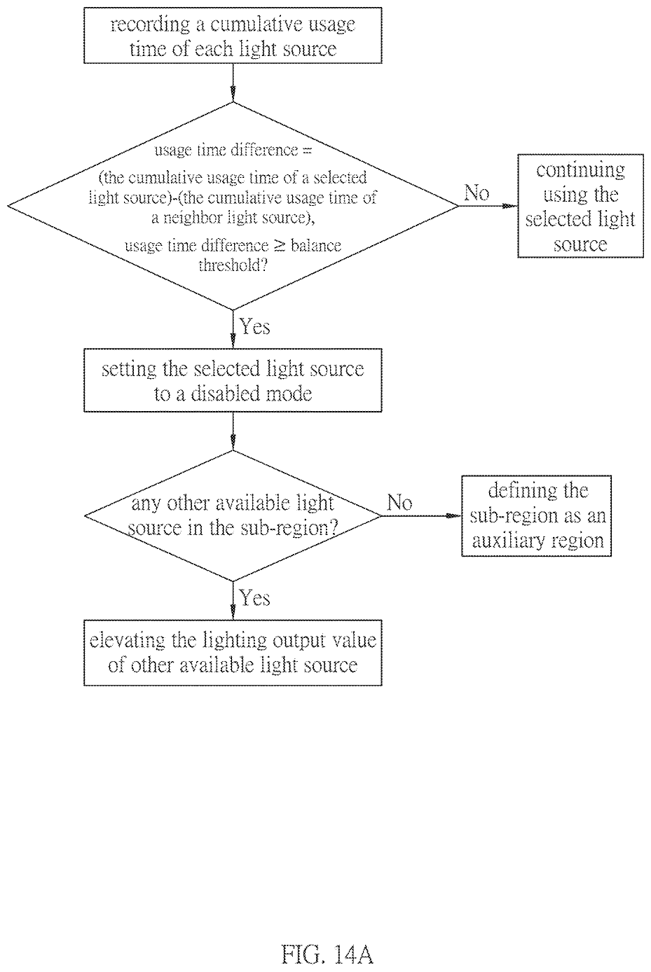

FIG. 13 shows a schematic diagram of the lighting space including an auxiliary region. In this embodiment, each of the sub-regions 10A and 10C has an available light source 400, while the light source 400 in the auxiliary region 10B′ is faulty. The auxiliary region 10B′ is detected with an object H therein. Accordingly, the step M2 of calculating the compensatory illuminance may be executed for the auxiliary region 10B′, and the step M3 of adjusting the lighting output value may be executed for the sub-regions 10A and 10C close to the auxiliary region 10B′. Therefore, the light sources 400 in the sub-regions 10A and 10C may provide compensatory lighting to the auxiliary region 10B′. When the light source 400 in the auxiliary region 10B′ becomes available (for example, being repaired or replaced), the auxiliary region 10B′ is re-assigned as a sub-region and adopts the lighting control method for sub-regions.

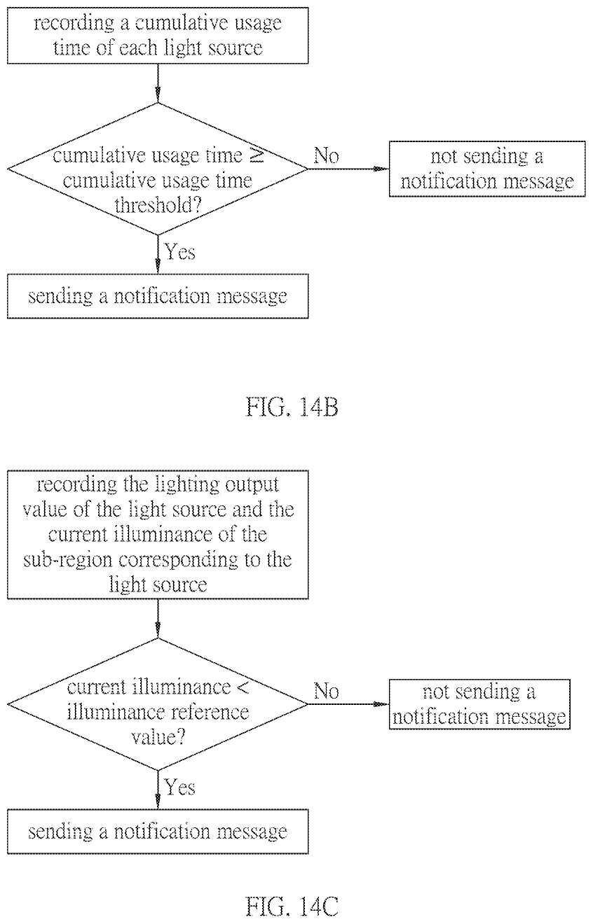

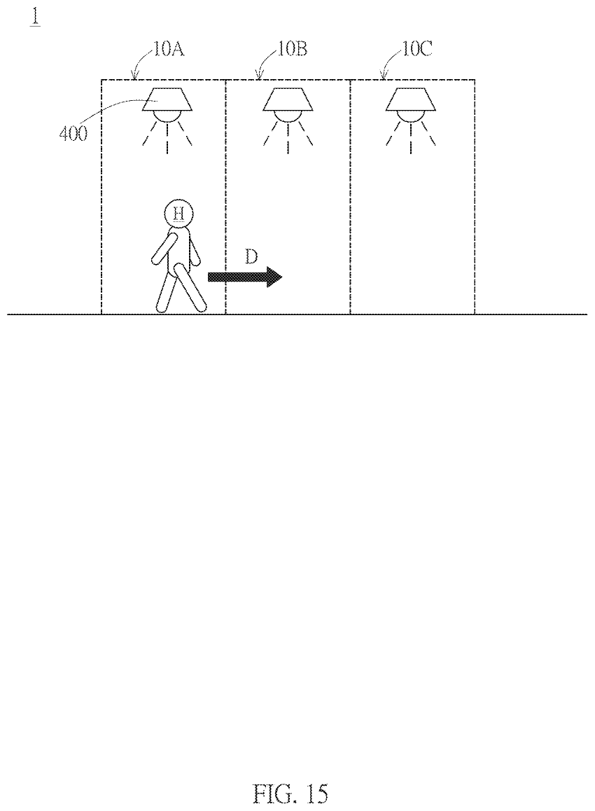

In an embodiment, the lighting control method in the present disclosure may further include the step of balancing the load of the light sources. As shown in FIG. 14A, in this step, a cumulative usage time of each light source is recorded. When a light source exhibits an excessively large difference in the cumulative usage time relative to the adjacent light source, the light source with the larger cumulative usage time is set to a disabled mode. For example, a usage time difference is defined as the cumulative usage time of a selected light source minus the cumulative usage time of another light source neighboring to the selected light source. In response to the usage time difference being greater than or equal to a balance threshold (which may be defined as such as 10% of the lifetime of the light source indicated by the manufacturer), the selected light source is set to a disabled mode. Meanwhile, other light sources close to the disabled light source may take over the lighting duty. If other available light source presents in the sub-region including the disabled light source, the lighting output value of the available light source may be elevated to make the illuminance of the sub-region meet the previous illuminance level (that is, the illuminance level before any light source is set to the disabled mode). Conversely, if no any other available light source presents in the sub-region including the disabled light source, the sub-region is then assigned to be an auxiliary region, and other sub-regions close to the auxiliary region is configured to provide compensatory lighting to the auxiliary region. Based on this setting, the load of the light source is balanced between adjacent light sources, preventing failure resulting from excessive use of individual light sources.

On the other hand, the lighting control method in the present disclosure may further include the step of warning light source overload. As shown in FIG. 14B, in this step, a cumulative usage time of each light source is recorded. In response to the cumulative usage time of a light source being greater than or equal to a cumulative usage time threshold (which may be defined as such as 90% of the lifetime of the light source indicated by the manufacturer), a notification message may be sent to the central control system to remind the manager that this light source is due for replacement. Similarly, when the light source malfunctions, a notification message may be sent to the central control system to warn that the light source requires repairment or replacement.

In addition, the lighting control method of the present disclosure may further include the step of warning light source bad performance. As shown in FIG. 14C, in this step, the lighting output value of each light source and the current illuminance of the corresponding sub-region are recorded. In response to the current illuminance being less than an illuminance reference value, a notification message may be sent to the central control system to remind the manager that this light source has bad performance and needs maintenance or replacement. The illuminance reference value may be defined corresponding to different lighting output values. In an embodiment, the illuminance reference value may be defined as 70% of the initial illuminance of the light source when the lighting output value is set above 80%, but not limited thereto. Moreover, for a sub-region with multiple light sources, the illuminance reference value may be defined corresponding to the initial illuminance contributed by all light sources. Based on this setting, the hardware condition of the light sources can be automatically monitored, and a warning can be provided prior to complete failure, allowing the light source to be replaced in advance by the manager.

In an embodiment, the lighting control method of the present disclosure further includes the step of controlling the variation rate of the lighting output value. In this step, the dimming rate range is defined, and the variation rate of the lighting output value of each light source is controlled within the dimming rate range. For example, the dimming rate range may be defined as a range of −15% to +15% per second. That is, the latter lighting output value is set between 85% to 115% of the former lighting output value with a one-second interval. Based on this setting, rapid changes in illuminance and light flickering are prevented, thereby improving the visual comfort of users. When the lighting output value of the light source is subjected to a larger variation, adjust the duration required for adjusting the lighting output value becomes longer. If a new lighting output value is generated by performing a new cycle of steps S1 to S4 (referring to FIG. 1) during the variation process to reach the previous lighting output value, the new lighting output value may replace the previous lighting output value to serve as the target of the variation process.

The lighting control method in the present disclosure may also include lighting adjustment corresponding to the movement of the object. As shown in FIG. 15, when an object H moves in the lighting space 1, the moving direction D of the object H may be analyzed, and the preset illuminance of at least one sub-region in front of the object H along the moving direction D may be elevated. For example, when the object H is in the sub-region 10A and moves along the moving direction D (such as walking to the right), the preset illuminance of the sub-region 10A is set to the working illuminance, and the sub-region 10B on the right side of the object H is set to the same working illuminance to light up the region where the object H is going to enter. Furthermore, the sub-region 10C, which is spaced relatively far to the right of the object H, may have a lower preset illuminance. The preset illuminance of the sub-region 10C may gradually increase with time (as the object H moves closer to the sub-region 10C), forming an optically guiding path. Based on this setting, lighting can be provided within a defined area ahead of a moving user, improving both convenience and safety.

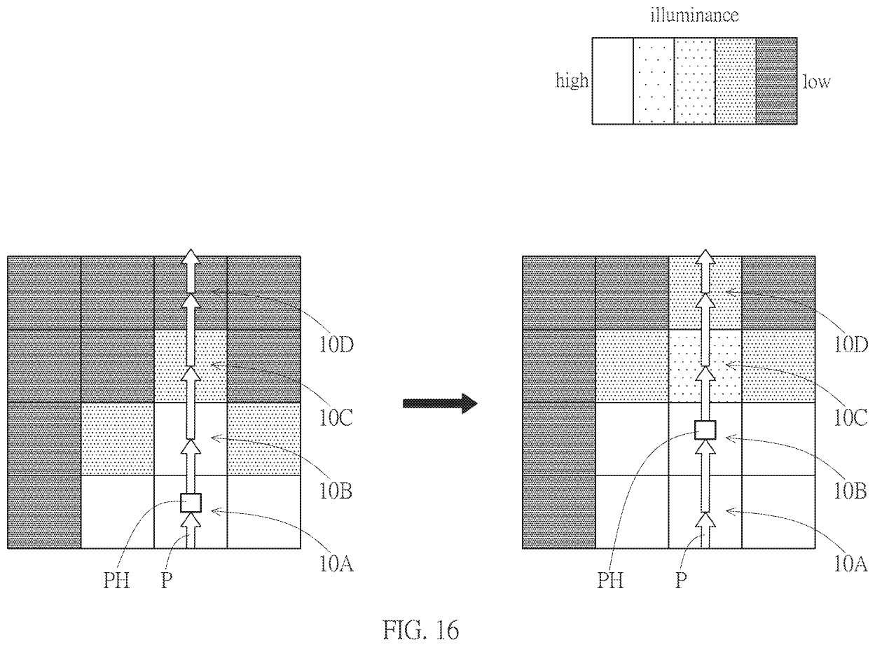

In the embodiment shown in FIG. 16, a preset moving route P may be input to the system for lighting scheduling. The preset moving route P may include, for example, a patrol route or a maintenance route, wherein the time point of the user entering each sub-region is also input to the system. After setting the preset moving route P, the preset illuminance of the sub-regions associated with (such as being located on or adjacent to) the preset moving route P may be elevated in a sequentially manner along the preset moving route P. For example, at the time point shown in the left drawing in FIG. 16, the preset position PH of the user is in the sub-region 10A, and the lighting source in the sub-region 10A and other sub-regions close to the sub-region 10A are turned on. Also, the system is configured to increase the illuminance of the sub-regions (such as 10C) that the user is expected to arrive later along the preset movement path P. The right drawing in FIG. 16 illustrates the illuminance distribution corresponding to the next time point, wherein the preset position PH of the user is moved into the sub-region 10B, and the lighting range is expanded along the preset movement path P to cover the sub-region 10D compared to the lighting range at the previous time point (as shown in the left drawing). The lighting durations associated with the preset movement path P may vary based on different requirements. For example, the sub-regions along a patrol route may have their lighting turned off after a certain period, whereas sub-regions along an inspection route may maintain their original brightness until the inspection is completed, but not limited thereto. Based on this setting, energy consumption in the preset movement mode can be reduced, and a path guidance function can be provided.

On the other hand, the lighting control method of the present disclosure may also include lighting scheme corresponding to static modes. When the user remains at a fixed workstation, a higher illuminance may be required (compared to the required illuminance when the user is moving). To determine whether the user stays at a stationary location, the duration that the object number of a sub-region remains greater than or equal to a threshold value is recorded. In response to the duration exceeding a dwell time threshold (such as 15 seconds, but not limited thereto), the preset illuminance of the sub-region may be increased. Based on this setting, short-term passage and long-term stay usage states can be distinguished, enabling accurate illumination and energy efficiency.

Values specified in the aforementioned embodiments may be adjusted depending on the lighting space type and usage. The same parameters appearing in different steps can denote either the same or distinct values. For instance, the threshold of the object number in steps S3 and S5 may be set to the same or different values.

In summary, the present disclosure provides a lighting control method and a lighting control system for executing the lighting control method, establishing zoned lighting corresponding to the object distribution and the current illuminance in a lighting space. By image analysis, regional data with high spatial resolution can be obtained, and neighboring region analysis logic is combined with the regional data to provide gradient lighting, thereby enhancing the visual comfort of users.

The present disclosure has been illustrated by the above embodiments. However, the above embodiments are only exemplary and are not to be regarded as limiting. Based on different designs, some components in one embodiment may be applied to another embodiment, but not limited thereto. The scope of the present disclosure is defined by the appended patent claims. Various changes and modifications to the present disclosure can be made by a person having ordinary skill in the art without departing from the spirit of the present disclosure, and that various changes and modifications fall within the scope of the present disclosure as defined by the appended patent claims.

What is claimed is:

1. A lighting control method for a lighting space, wherein the lighting space includes a plurality of sub-regions, each of the plurality of sub-regions at least includes a light source, and the lighting control method comprises:
receiving an image of the lighting space;
analyzing an object number and a current illuminance of each of the plurality of sub-regions based on the image;
for a target sub-region of the plurality of sub-regions, calculating a preset illuminance based on the object number of the target sub-region, the object number of a neighbor sub-region, and a distance between the target sub-region and the neighbor sub-region; and
for the target sub-region, calculating a lighting output value of the light source in the target sub-region based on a difference between the preset illuminance and the current illuminance.

2. The lighting control method of claim 1, wherein the step of calculating the preset illuminance includes:
in response to the object number of the target sub-region being greater than or equal to a threshold value, setting the preset illuminance to a working illuminance; and
in response to the object number of the target sub-region being less than the threshold value, calculating the preset illuminance based on the object number of the neighbor sub-region and the distance between the target sub-region and the neighbor sub-region.

3. The lighting control method of claim 1, further comprising:
for the target sub-region having the object number greater than or equal to a threshold value,
defining at least one sub-region in the plurality of sub-regions neighboring to the target sub-region as an associating sub-region,
defining an associating set including the target sub-region and the associating sub-region, and
calculating a lighting uniformity based on the current illuminance of each of the sub-regions in the associating set; and
for each of the sub-regions in the associating set,
calculating an illuminance-adjusting factor based on the lighting uniformity and the current illuminance; and
adjusting the preset illuminance based on the illuminance-adjusting factor.

4. The lighting control method of claim 3, wherein the lighting uniformity includes a first lighting uniformity, and the first lighting uniformity includes a ratio of a minimum value and an average value of the current illuminance of each of the sub-regions in the associating set.

5. The lighting control method of claim 3, wherein the lighting uniformity includes a second lighting uniformity, and the second lighting uniformity includes a ratio of a minimum value and a maximum value of the current illuminance of each of the sub-regions in the associating set.

6. The lighting control method of claim 3, wherein the step of calculating the illuminance-adjusting factor includes:
in response to the lighting uniformity being less than a lighting uniformity threshold,
for the sub-region having a maximum value of the current illuminance in the associating set, setting the illuminance-adjusting factor to a value less than 1; and
for the sub-region having a minimum value of the current illuminance in the associating set, setting the illuminance-adjusting factor to a value greater than 1.

7. The lighting control method of claim 3, wherein the step of adjusting the preset illuminance further includes:
defining a working illuminance threshold based on the lighting space; and
for the sub-region having the object number greater than or equal to the working illuminance threshold value, adjusting the preset illuminance to the larger one of the working illuminance threshold and the product of the preset illuminance previously obtained and the illuminance-adjusting factor.

8. The lighting control method of claim 3, wherein the step of adjusting the preset illuminance further includes:
defining a background illuminance threshold based on the lighting space; and
for the sub-region having the object number less than the background illuminance threshold value, adjusting the preset illuminance to the larger one of the background illuminance threshold and the product of the preset illuminance previously obtained and the illuminance-adjusting factor.

9. The lighting control method of claim 1, wherein the lighting space further includes at least one auxiliary region, and the lighting control method further comprises:
analyzing an object number and a current illuminance of the at least one auxiliary region based on the image to calculate a compensatory illuminance; and
adjusting the lighting output value of the sub-region close to the auxiliary region based on the compensatory illuminance.

10. The lighting control method of claim 9, wherein the step of calculating the compensatory illuminance further includes:
in response to the light source in the sub-region being in a disabled mode, defining the sub-region as the auxiliary region.

11. The lighting control method of claim 1, further comprising:
recording a cumulative usage time of each of the light sources; and
calculating a usage time difference corresponding to the cumulative usage time of a selected light source of the light sources minus the cumulative usage time of a neighbor light source of the light sources, in response to the usage time difference being greater than or equal to a balance threshold, setting the selected light source to a disabled mode.

12. The lighting control method of claim 1, further comprising:
recording a cumulative usage time of each of the light sources; and
defining a cumulative usage time threshold, in response to the cumulative usage time of the light source being greater than or equal to the cumulative usage time threshold, sending a notification message.

13. The lighting control method of claim 1, further comprising:
for each of the light sources,
recording the lighting output value of the light source and the current illuminance of the sub-region corresponding to the light source;
defining an illuminance reference value corresponding to the lighting output value, in response to the current illuminance of the sub-region corresponding to the light source being less than the illuminance reference value, sending a notification message.

14. The lighting control method of claim 1, further comprising:
defining a dimming rate range; and
variating the lighting output value of each of the light sources with a variation rate, wherein the variation rate falls in the dimming rate range.

15. The lighting control method of claim 14, wherein the step of defining the dimming rate range includes:
defining the dimming rate range as a range of −15% to +15% per second.

16. The lighting control method of claim 1, further comprising:
analyzing a moving direction of an object, and
increasing the preset illuminance of at least one of the plurality of sub-regions located in front of the object in the moving direction.

17. The lighting control method of claim 1, further comprising:
defining a preset moving route, and
increasing the preset illuminance of a portion of the plurality of sub-regions associated with the preset moving route in a sequentially manner along the preset moving route.

18. The lighting control method of claim 1, further comprising:
for each of the plurality of sub-regions, recording a duration of the object number remaining greater than or equal to a threshold value, in response to the duration exceeding a dwell time threshold, increasing the preset illuminance of the sub-region.

19. The lighting control method of claim 1, wherein the image includes a plurality of partition images at least partially overlapped with each other, and the lighting control method further comprises:
identifying an overlapped sub-region of the plurality of sub-regions corresponding to an overlapped region of at least two of the plurality of partition images,
calculating a partition object number and a partition current illuminance of the overlapped sub-region based on each of the at least two of the plurality of partition images; and
setting the object number to the largest one of the partition object numbers and the current illuminance to the smallest one of the partition current illuminances.

20. A lighting control system comprising:
an analyzing module for executing the lighting control method of claim 1 and sending an operation message including the lighting output values;
an optical sensor in signal communication with the analyzing module, wherein the optical sensor is used to obtain the image of the lighting space and transfer the image to the analyzing module;
the light sources disposed in the lighting space; and
a control module in signal communication with the analyzing module and the light sources, wherein the control module is used to receive the operation message and adjust the brightness of each of the light sources based on the lighting output value corresponding thereto.
